(19) United States
(12) Patent Application Publication
(10) Pub. No.: US 2004/0194311 A1
(43) Pub. Date: Oct. 7, 2004

(54) Method and apparatus for removing non-condensing gas within heat pipe

(76) Inventor: Hul Chun Hsu, Taichung (TW)

Correspondence Address: Yi-Wen Tseng, 509 ROOSEVELT BLVD. #D306, FALLS CHURCH, VA, 22044, US

(21) Appl. No.: 10/734,239

(22) Filed: Dec. 15, 2003

(30) Foreign Application Priority Data
Dec. 13, 2002 (TW) 91136209

(51) Int. Cl. B23P 6/00

(52) U.S. Cl. 29/890.032

(57) ABSTRACT

A method and an apparatus for removing non-condensing gas within a heat pipe are disclosed. A predetermined amount of a working fluid is filled into the heat pipe with an opening formed on a top end. The heat pipe is heated to obtain the working fluid with a saturated temperature and then the saturated temperature is maintained to have the working fluid being evaporated and boiled, such that the non-condensing gas is expelled by vapor of the working fluid. Finally, the opening is sealed when a predetermined amount of the vapor of the working fluid is discharged. The apparatus to perform the method includes a heater assembly providing the heat pipe installed therein and having a holder for holding the heat pipe to be positioned, and a sealer unit located above the heat assembly and having a clamping element and a driving mechanism to operate the clamping element.

### BACKGROUND OF THE INVENTION

The present invention relates generally to a method and an apparatus for removing vapor within a thermal tube and, more particularly, to a method and an apparatus that can remove non-condensing gas within a heat pipe while precisely controlling the amount of the working fluid to be sealed in the heat pipe.

Heat pipes, by having the features of quick thermal response, high thermal conductivity, no moving parts, simple structure and multi-functions, can transfer huge amount of heat without consuming significant amount of electricity. Therefore, heat pipes are suitable for heat dissipation of electronic products. In addition, the interior wall of the conventional heat pipe includes wick structure. The wick structure includes web for capillary effect, which is advantageous for transmission of working fluid in the heat pipe.

In fabricating the heat pipe, there exists a non-condensing gas within the heat pipe that needs to be removed. Conventionally, the non-condensing gas is expelled by heated outbursting vapor of the working fluid which is liquid in a normal state and is not dangerous to an operator, such as for the working fluid like water, Freon® 113, ethanol and etc. First, a slightly more amount of working fluid is filled in the heat pipe. An opening of the top end of the heat pipe is temporarily sealed to have the vapor tension inside reach to 0.2 to 0.4 MPa and then the heat pipe is heated. Next, the opening is reopened to equilibrate the pressure between the heat pipe and the atmosphere. By that, the working fluid will meet its flash point to burst out the vapor from the reopening outlet. Here, the flash point means a critical point of a substance momentarily change from liquid to vapor. Therefore, the non-condensing gas within the heat pipe is expelled by the vapor of the working fluid. Finally, under precise control, that is, the residual working fluid is calculated by the heating time and temperature in the procedures to determine the dispersion of the vapor, the opening is sealed again to obtain the heat pipe.

However, while during the above-mentioned fabrication, the non-condensing gas within the heat pipe is typically exhausted together with the liquid working fluid, such that the remaining amount of the working fluid within the heat pipe cannot be precisely controlled because when the reopening outlet is formed, the vapor bursts out rapidly and the dispersing amount of working fluid depends on uncertain size of the reopening outlet, and changeable time to form the outlet. The control quality of the heat pipes is thus very poor. Further, the reopening may result damage of the heat pipe, thus affect the quality.

Therefore, there exist inconvenience and drawbacks for practically application of the above conventional heat pipes. There is thus a substantial need to provide a method and an apparatus for removing vapor within a heat pipe that resolves the above drawbacks and can be used more conveniently and practically.

### BRIEF SUMMARY OF THE INVENTION

The present invention provides a method and an apparatus for removing non-condensing gas within a heat pipe. During the process of expelling the non-condensing gas, the residual amount of working fluid within the heat pipe can be precisely controlled by a heating period and the size of an original opening of the heat pipe without reopening. Therefore, a precise amount of the working fluid is maintained, heat pipes with improved quality are fabricated, and a better heat flow is obtained.

To achieve the above and other objectives, the present invention provides a method to remove non-condensing gas within a heat pipe. The method includes the following steps. First, a predetermined amount of a working fluid is filled into the heat pipe with an opening formed on a top end. The heat pipe is heated to obtain the working fluid with a saturated temperature and then the saturated temperature is maintained to have the working fluid being evaporated and boiled, such that the non-condensing gas is expelled by vapor of the working fluid. Finally, the opening is sealed when a predetermined amount of the vapor of the working fluid is discharged.

The apparatus provided by the present invention to perform the above-mentioned method includes a heater assembly providing the heat pipe installed therein and having a holder for holding the heat pipe to be positioned, and a sealer unit located above the heat assembly and having a clamping element and a driving mechanism to operate the clamping element.

### BRIEF DESCRIPTION OF THE DRAWINGS

These, as well as other features of the present invention, will become more apparent upon reference to the drawings wherein:

FIG. 1 shows a process of the method for removing non-condensing gas within a heat pipe according to the present invention;

FIG. 2 shows the initiating operation of the apparatus to perform the method provided by the present invention;

FIG. 3 shows the finishing operation of the apparatus according the present invention; and

FIG. 4 shows a cross-sectional view along a line 4-4 of FIG. 2.

### DETAILED DESCRIPTION OF THE INVENTION

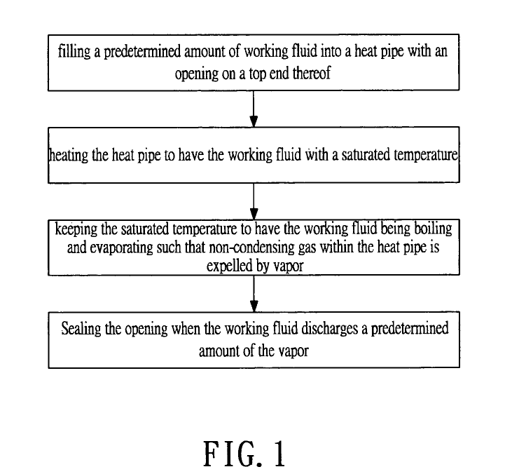

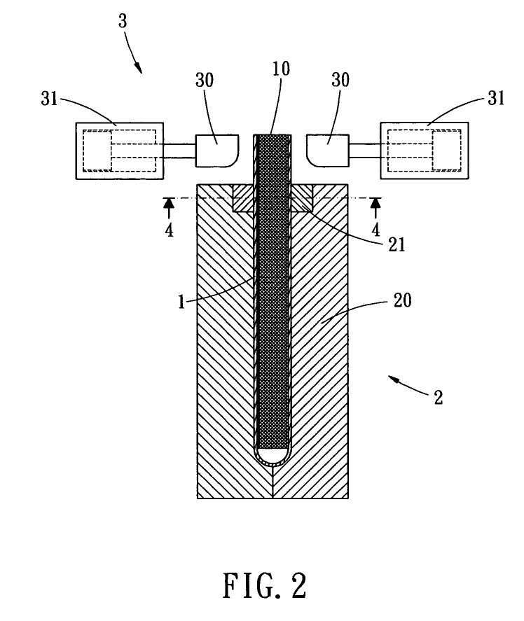

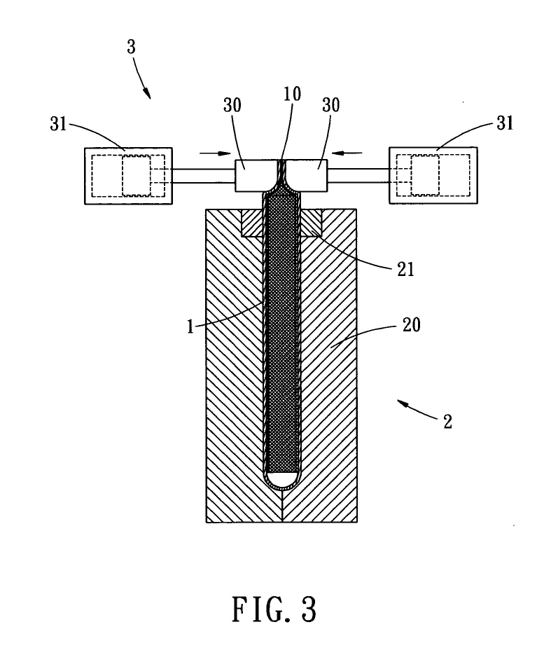

Referring to FIGS. 1 to 3, the process flow of the method and operation of the apparatus for removing non-condensing gas within a heat pipe provided by the present invention are illustrated. The method includes step a) filling a predetermined amount of working fluid into a heat pipe 1 (as shown in FIG. 2). An opening 10 is reserved at top end of the heat pipe 1. Preferably, the predetermined amount is slightly more than the amount of working fluid to be sealed in the heat pipe 1. The interior wall of the heat pipe 1 includes wick structure, while the opening is formed at the sealing end of the heat pipe 1.

The following step b) is for heating the heat pipe to obtain the working fluid with a saturate temperature which indicates a boiling point of the working fluid.

Thereafter, as in step c), keep the saturated temperature to have the working fluid being evaporated and boiled, such that the non-condensing gas is expelled by vapor of the working fluid through the opening 10. In this step, the working fluid can be mildly evaporated to achieve more precise control of the sealing working fluid by conducting adequate heat to avoid too violent evaporation from spitting out the liquid working. Although the heating period may be protended, the dispersion of the vapor can be steadily dominated.

Instead, while less heating time, lower cost and more efficiency are concerned, the working fluid can also be acceleratedly evaporated by conducting more heat.

The last step d) is for sealing the opening 10 when a predetermined amount of the vapor of the working fluid is discharged.

By the above processes, a heat pipe 1 within which the non-condensing gas has been exhausted is obtained.

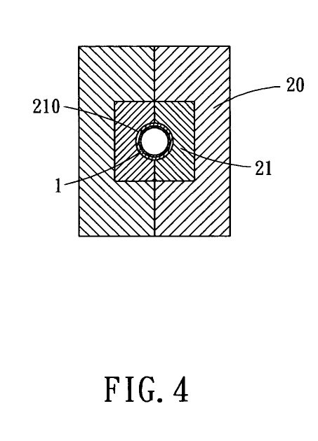

Referring to FIGS. 2 to 4, the present invention further provides an apparatus to perform the above-mentioned method for removing the non-condensing gas within the heat pipe 1. The apparatus includes a heater assembly 2 and a sealer unit 3.

The heater assembly 2 further includes a heater 20 for controlling the heat conduction and the operation time to the heat pipe 1 installed therein, and a holder 21 for holding the heat pipe 1 to be positioned.

The sealer unit 3 further includes a clamping element 30 and a driving mechanism 31 to operate the clamping element 30. The sealer unit 3 is located above the heat assembly 2 with the clamping element 30 aiming the sealing end of the heat pipe 1 to perform the sealing operation of the opening 10.

Furthermore, the holder 21 with a fitting 210 and the clamping element 30 can be modulized to be disassembled from the heat assembly 2 and the sealer unit 3, respectively, and to be switched for various heat pipes with different kinds and sizes of the opening 10.

According to the above, an apparatus for removing non-condensing gas within a heat pipe is obtained.

Moreover, in step b), the clamping element 30 can be used to squeeze the opening 10 before or during the heating so that the opening 10 is reduced for facilitating the discharge of the non-condensing gas, enhancing steady control of the discharge and preventing the heat pipe 1 from contaminate.

Next, in step d), the clamping element 30 can have a temperature no less than the saturated temperature of the working fluid, and is contacted to the heat pipe 1 at the sealing end without entirely sealing the opening 10. As such, the discharging vapor is not tended to condense near the opening 10. Therefore, the quality of the working environment of the apparatus and the sealing end of the heat pipe 1 are maintained, and the possibility of condensed working fluid accumulated around the opening 10 to influence the discharge is prevented.

Accordingly, the method and apparatus for removing the non-condensing gas within the heat pipe according to the present invention has at least the following advantages.

1. During the heating step, the discharging outlet of the opening is predetermined. Compared to the prior art, the opening is sealed and then reopened with variable reopening outlet. Therefore, the amount of the working fluid to be sealed in the heat pipe is more precisely controlled.

2. The apparatus for operating the present method can be readily manufactured and with modulization to be provided for fabrication of different heat pipes.

3. It is much safer to expel the non-condensing gas by consistently generating vapor of the working fluid than the conventional method.

4. The structure of the heat pipe is not damaged by sealing, reopening and sealing again the opening as in the conventional method

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A method of removing non-condensing gas within a heat pipe, comprising:
filling a predetermined amount of liquid working fluid into the heat pipe with an opening on a top end thereof;
heating the heat pipe to obtain the working fluid with a saturated temperature;
maintaining the saturated temperature to have the working fluid being evaporated and boiled, such that the non-condensing gas within the heat pipe is discharged by vapor of the working fluid; and
sealing the opening when a predetermined amount of the vapor of the working fluid is discharged.

2. The method of claim 1, wherein the saturated temperature indicates a boiling point of the working fluid.

3. The method of claim 1, further comprising the step of reducing the size of the opening for discharging the non-condensing gas.

4. The method of claim 1, wherein the working fluid is mildly evaporated to achieve more precise control of the sealed working fluid in the heat pipe by conducting heat to avoid too violent evaporation so that the liquid working fluid does not spit out of the heat pipe.

5. The method of claim 1, wherein the working fluid is acceleratedly evaporated by conducting heat to have the liquid working fluid spits out of the heat pipe.

6. The method of claim 1, further comprising the step of keeping a temperature around of the opening not less than the saturated temperature of the working fluid.

7. An apparatus for removing non-condensing gas within a heat pipe by filling a predetermined amount of working fluid into the heat pipe with an opening on a top end, heating the heat pipe to obtain the working fluid with a saturated temperature, maintaining the saturated temperature to have the working fluid being evaporated and boiled so as to discharge the non-condensing gas, and sealing the opening when a predetermined amount of the vapor of the working fluid is discharged, the apparatus comprising:
a heater assembly providing the heat pipe installed therein, and including a holder for holding the heat pipe to be positioned; and
a sealer unit located above the heat assembly, and including a clamping element and a driving mechanism to operate the clamping element.

8. The apparatus of claim 7, wherein the heater assembly further includes a heater for controlling the heat conduction and the heat operation time to the heat pipe.

9. The apparatus of claim 7, wherein the holder is modulized to be disassembled from the heat assembly, and to be switched for various heat pipes with different sizes of the opening.

10. The apparatus of claim 7, wherein the holder includes a fitting for various heat pipes with different sizes of the opening.

11. The apparatus of claim 7, wherein the clamping element is modulized to be disassembled from the sealer unit, and to be switched for various heat pipes with different sizes of the opening.
